(19) United States
(12) Patent Application Publication
(10) Pub. No.: US 2017/0169546 A1
(43) Pub. Date: Jun. 15, 2017

(54) METHOD AND ELECTRONIC DEVICE FOR ADJUSTING PANORAMIC VIDEO

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Shiwang CUI, Beijing (CN); Yingjie WANG, Beijing (CN)

(21) Appl. No.: 15/245,048

(22) Filed: Aug. 23, 2016

Related U.S. Application Data
(63) Continuation of application No. PCT/CN2016/089240, filed on Jul. 7, 2016.

(30) Foreign Application Priority Data
Dec. 11, 2015 (CN) 201510921118.2

(51) Int. Cl. G06T 3/60; G06T 3/00

(52) U.S. Cl. CPC G06T 3/60; G06T 3/0043

(57) ABSTRACT

Embodiments of the present disclosure disclose a method and a device for adjusting a panoramic video 1. The method comprises: obtaining a gravity sensing parameter of an electronic device; calculating an included angle α between a direction of the gravity sensing parameter and a negative axis of an x-axis, of the electronic device, wherein the included angle α is an angle of which the direction of the gravity sensing parameter clockwise rotates to the negative axis of the x-axis: a panoramic model of a panoramic video is anticlockwise rotated by the angle α relative to the negative axis of the x-axis to keep images of the panoramic video horizontal. By means of the method, the images of the panoramic video can be always kept horizontal.

### CROSS-REFERENCE TO RELATED APPLICATIONS

The present disclosure is a continuation of International Application No, PCT/CN2016/089240 filed on Jul. 7, 2016, which is based upon and claims priority to Chinese Patent Application No, 201510921118,2, filed Dec. 11, 2015, and the entire contents of all of which are incorporated herein by reference.

### TECHNICAL FIELD

The present disclosure generally relates to the technical field of mobile terminals, and in particular, to a method and an electronic device for adjusting a panoramic video.

### BACKGROUND

With the rapid growth of mobile terminals such a.s smart phones, tablet computers and the like, the development of mobile video applications is promoted; meanwhile, the increase of the number of panoramic video sources and the emergence of virtual reality equipment lead to that playing of panoramic videos becomes more and more popular. When a panoramic video is played on a mobile terminal, a user can adjust a view angle of a playing image of the panoramic video according to a touch operation on the mobile terminal or by rotating the mobile terminal. Head-wearing virtual reality (VR) equipment is used by a user; when the user rotates the head, a gyroscope of the YR equipment senses the rotation and then the view angle is adjusted correspondingly to make the user immersive.

At present, when a panoramic video is shown on a mobile terminal, display image of the panoramic video will tilt along with tilting of the mobile terminal and cannot be kept horizontal; users are more accustomed to the horizontal view angle and unaccustomed to adjust the view angle along with the rotation of the mobile terminal.

### SUMMARY

Embodiments of the present disclosure disclose a method and an electronic device for adjusting a panoramic video, which are intended to solve the problem that due to tilting of display images along with tilting of an existing mobile terminal when a par oramic video is played on the mobile terminal.

To solve the problem above, an embodiment of the present disclosure discloses a method for adjusting a panoramic video, applied to an electronic device and including:

obtaining a gravity sensing parameter of the electronic device;

calculating an included angle α between a direction of the gravity sensing parameter and a negative axis of an x-axis of the electronic device, the included angle α being an angle of which the direction of the gravity sensing parameter clockwise rotates to the negative axis of the x-axis, wherein a positive axis direction of the x-axis is a direction of which a center of gravity o is perpendicular to a long side of the electronic device and extends upwards; a positive axis direction of a y-axis is a direction of which the center of gravity o is perpendicular to a broad side of the electronic device and extends toward a upper part of the electronic device: a positive axis direction of a z-axis is a direction of which the center of gravity o extends in a direction that a front side of the electronic device faces; the positive axis directions of the x-axis, the y-axis and the z-axis are all determined on the basis of a direction of which the front side of the electronic device faces a user and the upper part of the electronic device is placed on a right side:

rotating a panoramic model of the panoramic video by a anticlockwise relative to the negative axis of the x-axis to keep images of the panoramic video horizontal.

Correspondingly, an embodiment of the present disclosure discloses an electronic device for adjusting a panoramic video, including: at least one processor; and a memory communicably connected with the at least one processor for storing instructions executable by the at least one processor, wherein execution of the instructions by the at least one processor causes the at least one processor to perform any one of the method described above in the disclosure.

An embodiment of the present disclosure discloses a non-volatile computer-readable storage medium stored with computer executable instructions, the computer executable instructions perform any one of the method described above in the disclosure.

### BRIEF DESCRIPTION OF THE DRAWINGS

One or more embodiments are illustrated by way of examples, and not by limitation, in the figures of the accompanying drawings, wherein elements having the same reference numeral designations represent like elements throughout. The drawings are not to scale, unless otherwise disclosed.

FIG. 1 is a step flow diagram of a method for adjusting a panoramic video in a first embodiment of the present disclosure.

FIG. 2 is schematic diagram of xyz coordinates of a mobile terminal in the first embodiment of the present disclosure.

FIG. 3 is a schematic diagram of an included angle α between a direction of a gravity acceleration g and a negative axis of an x-axis of the mobile terminal in the first embodiment of the present disclosure.

FIG. 4(1) FIG. 4(4) are schematic diagrams of four states of the mobile terminal in the first embodiment of the present disclosure.

FIG. 5 is a structural schematic diagram of a device for adjusting a panoramic video in a second embodiment of the present disclosure.

FIG. 6 schematically shows a block diagram of an electronic device for executing a method according to embodiments of the present disclosure.

### DESCRIPTION OF THE EMBODIMENTS

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part of embodiments of the present disclosure, but not all embodiments. On the basis of the embodiments in the present disclosure, all the other embodiments obtained by a person skilled in the art without creative work should fall into tl.e scope of protection of the present disclosure.

A method for adjusting a panoramic video provided by embodiments of the present disclosure will be introduced in detail herein. The method is applied to an electronic device. The electronic device in this embodiment of the present disclosure can be a smart mobile terminal, for example, a smart phone and a tablet computer.

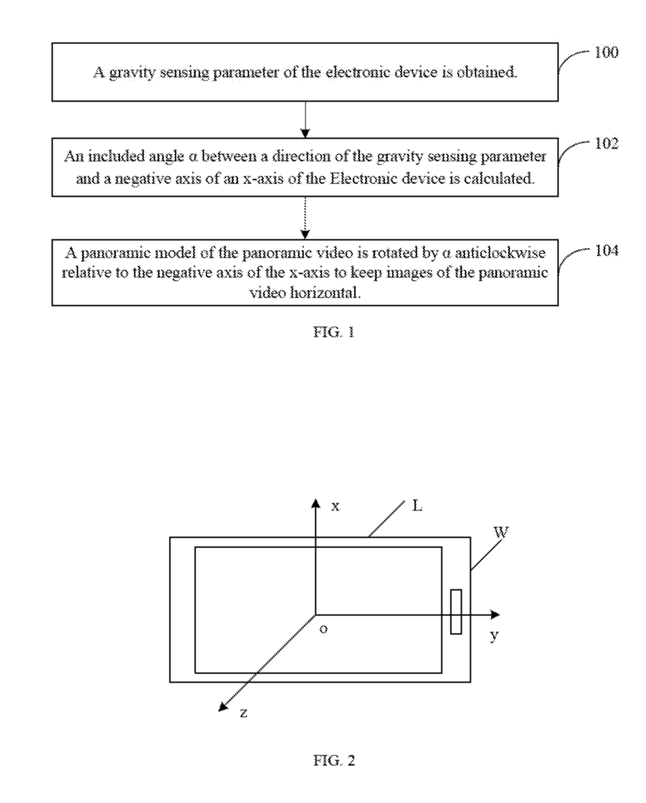

By referring to FIG. 1, illustrated is the step flow diagram of the method for adjusting a panoramic video in the first embodiment of the present disclosure.

In step 100, a gravity sensing parameter of an electronic device is obtained.

In this embodiment of the present disclosure, the gavity sensing parameter may be a gravity acceleration g which that can be measured by means of a gravity sensor of the electronic device.

In addition to obtaining the gravity sensing parameter, related sensor parameters may also be obtained according to related sensors of the electronic device. The gravity sensing parameter in this embodiment of the present disclosure is one of the sensor parameters.

In step 102, an included angle α between a direction of the gavity sensing parameter and a negative axis of an x-axis of the electronic device is calculated.

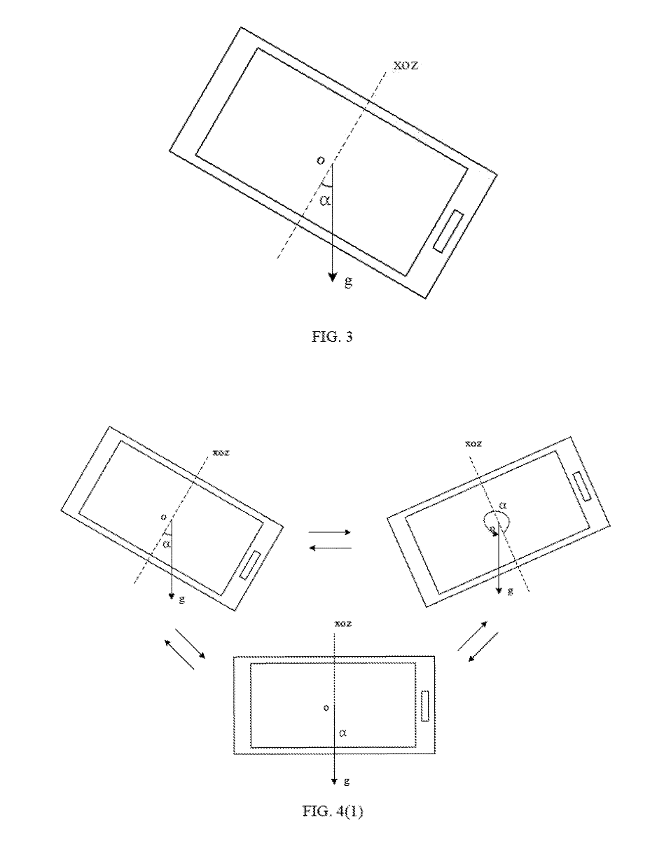

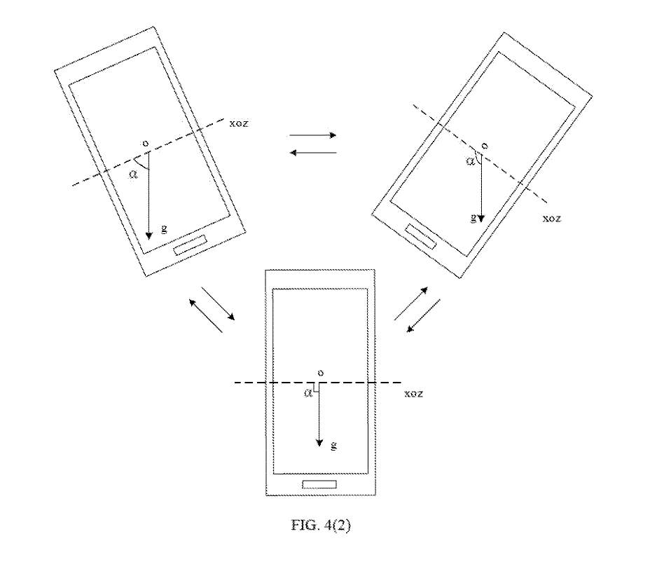

A front panel of the electronic device therein is rectangular; a long side of the front panel is a long side of the electronic device, i.e., edge L in FIG. 2; a broad side of the front panel is a broad side of the electroMc device, i.e., edge W in FIG. 2; a high edge of the electronic device that is not shown in FIG. 2 is perpendicular to an xoy plane. The included angle α between the direction of the gravity acceleration g and the negative axis of the x-axis of the electronic device is as shown in FIG. 3, which is an angle α by which the direction of the gravity acceleration g clockwise rotates to the negative axis of the x-axis, wherein a positive axis direction of the x-axis is a direction where a direction of a center of gravity o is perpendicular to the long side (L) of the electronic device and extends upwards; a positive axis direction of a y-axis is a direction where the direction of the center of gravity o is perpendicular to the broad side (W) of the electronic device and extends toward an upper part of the electronic device; a positive axis direction of a z-axis is a direction where the direction of the center of gavity o extends in a direction that a front side of the electronic device faces. The above positive axis directions of the x-axis, the y-axis and the z-axis are all determined on the basis of a direction where the front side of the electronic device faces a user and the upper part of the electronic device is placed on a right side, as shown in FIG. 2. When the electronic device rotates, the x, y and z axes rotate correspondingly, but still keep a position relation relative to the electronic device.

Specifically, the step 102 may include:

the components of the gravity acceleration g in the x-axis, the y-axis and the z-axis as gₓ, g_{y} and g_{z}, are determined, respectively.

When gₓ is less than 0 and g_{y} is greater than or equal to 0,

$$α = arcsin \frac{\vert {ℊ}_{y} \vert}{\sqrt{{{ℊ}_{x}}^{2} + {{ℊ}_{y}}^{2}}} .$$

When gₓ is greater that or equal to 0 g_{y} is also greater than or equal to 0,

$$α = 180 - arcsin \frac{\vert {g}_{y} \vert}{\sqrt{{g}_{x}^{2} + {g}_{y}^{2}}} .$$

When gₓ is greater man or equal to 0 and g_{y} is less than 0,

$$α = 180 + arcsin \frac{\vert {g}_{y} \vert}{\sqrt{{g}_{x}^{2} + {g}_{y}^{2}}} .$$

When gₓ, is less than 0 and g_{y} is also less than 0,

$$α = 360 - arcsin \frac{\vert {g}_{y} \vert}{\sqrt{{g}_{x}^{2} + {g}_{y}^{2}}} .$$

In step 104, a panoramic model of the panoramic video is anticlockwise rotated by the angle α relative to the negative axis of the x-axis to keep images of the panoramic video horizontal.

When the panoramic video is played on the electronic device, regardless of the state of the electronic device, compensation can be performed using the included angle α. The specific compensation process is described in the above step 104.

In an alternative embodiment of the present disclosure, when a user watches a panoramic video on the electronic device, if the user wants to adjust a view angle of the panoramic video using a gesture operation or a gyroscope of the electronic device, the following processes need to be carried out:

After the above step 102, a state of the electronic device inay also be determined according to the included angle α.

The electronic device may have four states, i.e., a positive landscape state, a positive portrait state, a negative landscape state and a negative portrait state.

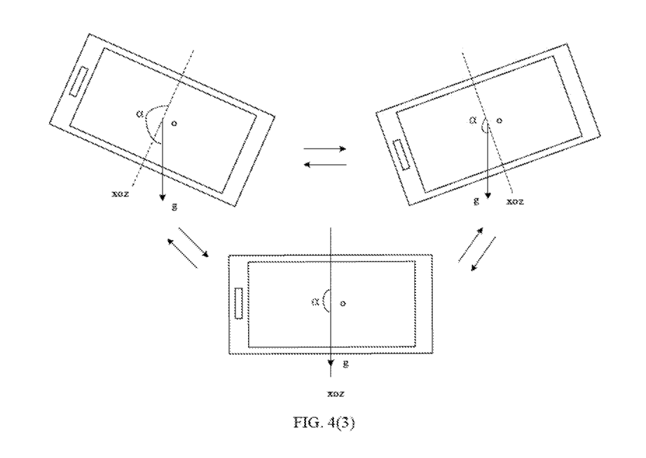

Specifically, when the included angle α is greater than 315 degrees and less than or equal to 360 degrees, or greater than 0 and less than or equal to 45 degrees, the electronic device is in the positive landscape state, as shown in FIG. 4(1); when the included angle α is greater than 45 degrees and less than or equal to 135 degrees, the electronic device is in the positive portrait state, as shown in FIG. 4(2): when the included angle α is greater than 135 degees and less than or equal to 225 degrees, the electronic device is in the negative landscape state, as shown in FIG. 4(3): when the included angle α is greater than 225 degrees and less than or equal to 315 degrees, the electronic device is in the negative portrait state, as shown in FIG. 4(4).

After the state f the electronic device is determined, an adjustment parameter of the panoramic video is determined according to the state of the electronic device. Specifically, the adjustment parameter of the panoramic video is determined as (+Δx, +Δy) when the electronic device is in the positive landscape state; the adjustment parameter of the panoramic video is determined as (−Δy, +Δx) when the electronic device is in the positive portrait state; the adjustment parameter of the panoramic video is determined as (−Δx, −Δy) when the electronic device is in the positive landscape state; the adjustment parameter of the panoramic video is determined as (+Δy, −Δx) when the electronic device is in the positive portrait state.

Δx therein represents a displacement of the center of gravity o in the x-axis along with a change of the state of the electronic device, while Δy represents a displacement of the center of gravity o in the y-axis along with the change of the state of the electronic device.

An adjustment direction of the panoramic model of the panoramic video is determined according to the obtained adjustment parameter. The panoramic model is a real-scene data model capable of three-dimensional manipulation that is established using processed basic data, i.e., acquired discrete images or a continuous video. A user can perform such operations as going forward, staying back, turning and 360-degree looking around, just like entering a space.

In conclusion, the view angle of a user can be avoided tom changing along with the tilting of the electronic device and the experience of the user is enhanced by means of the technical solution in this embodiment of the present disclosure,. i.e., obtaining the gravity sensing parameter of the electronic device, calculating the included angle α between the direction of the gravity sensing parameter and the x-axis of the electronic device, the included angle α being the angle of which the direction of the gravity sensing parameter clockwise rotates to the negative axis of the x-axis, and anticlockwise rotating the panoramic, model of the panoramic video by the angle α relative to the negative axis of the x-axis to keep images of the panoramic video horizontal.

Furthermore, after the images of the panoramic video are kept horizontal, if the user adjusts the view angle of the panoramic video using the touch operation or the gyroscope of the electronic device, the adjustment direction of the panoramic model is determined using the obtained adjustment parameter. Therefore. the problem of reversed operations in the panoramic video playing process is solved.

A device for adjusting a panoramic video provided by embodiments of the presentdisclosure will be introduced in detail herein. The device is applied to an electronic device.

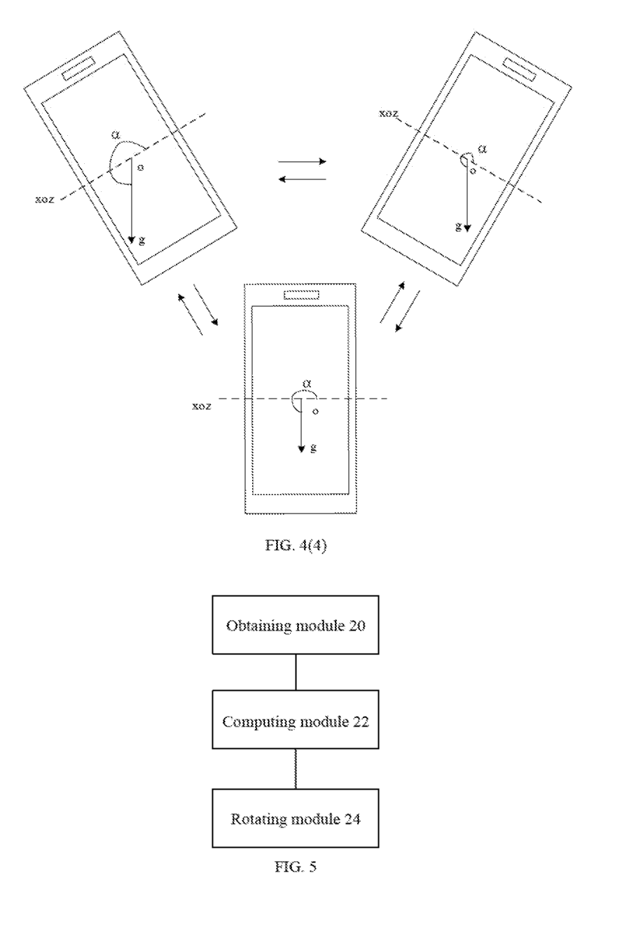

By referring to FIG. 5. illustrated. is the structural schematic diagram of the device for adjusting a panoramic video in the second embodiment of the present disclosure. The electronic device in this embodiment of the present disclosure is used to play panoramic videos, and can be smart electronic device, for example, a smart phone and a tablet computer

The adjusting device may include: an obtaining module 20, a calculating module 22 and a rotating module 24.

Functions of the modules and relations between the modules will be introduced in detail below, respectively.

The obtaining module 20 obtains a gravity lsing parameter of the electronic device.

The calculating module 22 calculates an included angle α between a direction of the gravity sensing parameter and a negative axis of an x-axis of the electronic device, the included angle α being an angle of which the direction of the gravity sensing parameter clockwise rotates to the negative axis of the x-axis, wherein a positive axis direction of the x-axis is a direction where a direction of a center of gravity o is perpendicular to a long side of the electronic device and extends upwards; a positive axis direction of a y-axis is a direction where the direction of the center of gravity o is perpendicular to a broad side of the electronic device and extends toward an upper part of the electronic device; a positive axis direction of a z-axis is a direction where the direction of the center of gravity o extends in a direction that a front side of the electronic device faces; the positive axis directions of the x-axis, the y-axis and the z-axis are all determined on the basis of a direction where the front side of the electronic device faces a user and the upper part of the electronic device is placed on a right side.

The rotating module 24 rotates a panoramic model of the panoramic video by the angle α anticlockwise relative to the negative axis of the x-axis to keep images of the panoramic video horizontal.

The adjusting device may also include: a state determining module, which determines a state of the electronic device according to the included angle α after the calculating module 22 calculates the included angle between the direction of the gravity sensing parameter and the negative axis of the x-axis of the electronic device. The state determine module determines the electronic device is in a positive landscape state when the included angle α is greater than 315 degrees and less than or equal to 360 degrees, or geater than 0 and less than or equal to 45 degrees, determines that the electronic device is in a positive portrait state when the included angle α is greater than 45 degrees and less than or equal to 135 degrees, determines that the electronic device is in a negative landscape state when the included angle α is greater than 135 degrees and less than or equal to 225 degrees, and determines that the electronic device is in a negative portrait state when the included angle α is greater than 225 degrees and less than or equal to 315 degrees.

The adjusting device may farther include: a parameter determining module, which determines an adjustment parameter of the panoramic video according to the state of the electronic device after the state determining modulate determines the state of the electronic device according to the included angle α. The parameter determining module determines the adjustment parameter of the panoramic video as (+Δx, +Δy) when the electronic device is in the positive landscape state, determines the adjustment parameter of the panoramic video as (−Δy, +Δx) when the electronic device is in the positive portrait state, determines the adjustment parameter of the panoramic video as (−Δx, −Δy) when the electronic device is in the positive landscape state, and determines the adjustment parameter of the panoramic video as (+Δy, −Δx) when the electronic device is in the positive portrait state.

Δx therein represents a displacement of the center of gravity o in the x-axis along with a change of the state of the electronic device, while Δy therein represents a displacement of the center of gravity o in the y-axis along with the change of the state of the electronic device.

In conclusion, the view angle of a user can be avoided from changing along with the tilting of the electronic device and the experience of the user is enhanced by means of the technical solution in this embodiment of the present disclosure, i.e., obtaining the gravity sensing parameter of the electronic device, calculating. the included angle α between the direction of the gravity sensing parameter and the x-axis of the electronic device, the included angle α being the angle of which the direction of the gravity sensing parameter clockwise rotates to the negative axis of the x-axis, and anticlockwise rotating the panoramic model of the panoramic video by the angle α relative to the negative axis of the x-axis to keep images of the panoramic video horizontal.

Furthermore, after the images of the panoramic video are kept horizontal, if the user adjusts the view angle of the panoramic video using the touch operation or the gyroscope of the electronic device, the adjustment direction of the panoramic model is determined using the obtained adjustment parameter. Therefore, the problem of reversed operations in the traditional panoramic video playing process is solved.

Another embodiment of the present disclosure further provides a mobile terminal including the device for adjusting a panoramic video described in the above embodiment

The embodiments of the adjusting device and the mobile terminal described above are merely schematic, wherein the units illustrated as separate components may be physically separated or not; components displayed as units may be physical units or not, which can be located at the same place or distributed to a plurality of network modules. Part or all modules may be selected according to actual requirements to achieve the purposes of the solutions of the embodiments. A person skilled in the art can understand and implement the solutions without creative work.

The component embodiments of the present disclosure may be realized by hardware, or software modules running in one or more processors, or a combination thereof. It should be appreciated by a person skilled in the art that a microprocessor a digital signal processor (DSP) can be employed in practice to realize some or all functions of some or all components in the electronic device according to the embodiment of the present disclosure. The present disclosure may also be implemented as an apparatus or a device program (e.g.. a computer program and a computer program product) used to execute part of or all the method described herein. Such a program for implementing the present disclosure may be stored in a computer-readable medium or may be in the form of one or more signals. Such signals may be downloaded from Internet websites, or provided on carrier signals, or provided in any other form.

Embodiments of the present disclosure further provide a non-volatile computer-readable storage medium, the non-volatile computer-readable storage medium is stored with computer executable instructions which are configured to perform any of the embodiments described above of the method for adjusting a video.

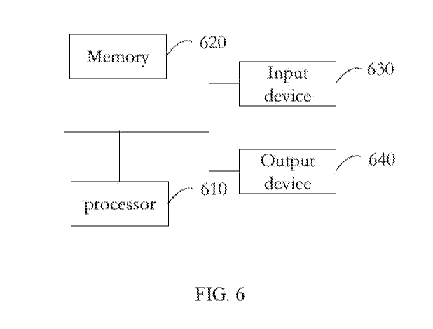

FIG. 6 is a structural schematic diagram showing the electronic device for executing the method for adjusting a panoramic video above. As shown in FIG. 6, the electronic, device includes:

at least one processor 610 and memories 620, in FIG. 6, one processor 610 is taken as an example.

The electronic device for executing the method for adjusting the panoramic video may include: an input device 630 and an output device 640.

The processor 610, the memory 620, the input device 630 and the output device 640 are connected through buses or other connecting ways. In FIG. 6, a bus connection is taken as an example.

The memory 620 is a non-volatile computer readable storage medium which may be used to store non-volatile software program, non-volatile computer-executable program and modules such as the program Mstructionsimodules (such as the obtaining module 20, the computing module 22, and the rotating module 24 shown in FIG. 5) corresponding to the method for adjusting the panoramic video according to the embodiment of the present disclosure. The processor 610 executes various functions and applications of the electronic device and performs data processing by operating the non-volatile software programs, instructions and modules stored in the memory 620, that is, executes the method for adjusting the panoramic video according to the method embodiments above.

The memory 620 may include a program storage section and a data storage section. Wherein the program storage section may store operating system and application needed by at least one function, and the data storage section may store the established data according to the device for adjusting the panoramic video. In addition, the memory 620 may include a high-speed random access memory, and may also include a non-volatile memory such as at least a disk memory device, flash memory device or other non-volatile solid-state storage devices. In some embodiments, the memory 620 may include a remote memory away from the processor 610. The remote memory may be connected to the device for adjusting the panoramic video via network. The network herein may include Internet, interior network in a company, local area network, mobile communication network and the combinations thereof.

The input device 630 may receive input numbers or characteristics information, and generate key signal input relative to the user setting and function control of the device for adjusting the video. The output device 640 may include display devices such as a screen.

The one or more modules are stored in the memory 620, when executed by the one or more processors 610, the methods for adjusting the panoramic video in the above method embodiments are executed.

The product may execute the method provided according to the embodiment of the present disclosure, and it has corresponding functional modules and beneficial effects corresponding to the executed method. The technical details not illustrated in the current embodiment may be referred to the method embodiments of the present disclosure.

In addition, typically, the electronic device described in the present disclosure may be various hand-held terminal devices, for example, cellphone and personal digital assistance (PDA); therefore the protection scope of the present disclosure should not define the electronic device of one certain type.

Moreover, the method according to the present disclosure may also be implemented as a computer program executed by a CPU. The computer program may be stored in a computer-readable storage medium. When the computer program is executed by the CPU, the functions defined in the method in the method of the present disclosure are executed.

Furthermore, the above method steps and the system units may also be implemented using a controller and a computer-readable storage medium for storing a computer program enabling the controller to realize the steps or the functions of the units.

It further will be understand by a person skilled in the art that various exemplary logical blocks, modules, circuits and algorithm methods described in conjunction with the present disclosure may be realized as electronic hardware, computer software, or a combination of both hardware and software. In order to clearly illustrate the interchangeability of hardware and software, general descriptions are already made to the functions of the various schematic modules, blocks, modules, circuits and steps. Whether the functions are implemented as software or hardware depends on specific applications and design constraints applied to the whole system. A person skilled in the art can realize the functions in various ways with regard to each specific application, but the decision of realization should not be interpreted as resulting in departing from the scope of the present disclosure.

Various schematic logical blocks, modules and circuits described in conjunction with the present disclosure can be implemented or executed using the following components designed to execute the functions described herein: a universal processor, a digital signal processor (DSP), an application specific integrated circuit (ASIC), a field programmable gate array (FPG), or other programmable logic devices, discrete gates or transistor logic, discrete hardware modules or any combination of these components. The universal processor may be a. microprocessor; however, alternatively, the processor may be any traditional processor, a controller, a microcontroller, or a state machine. The processor may also be implemented as a combination of computing devices, for example, the combination of the DSP and the microprocessor, a plurality of microprocessor, the combination of one or more microprocessors with a DSP core, or any other such configuration.

Steps of a iethod or an algorithm described in conjunction with the present disclosure may be directly included in hardware, software modules executed by a processor, or a combination thereof. The software modules may reside in an RAM memory, a flash memory, an ROM memory, an EPROM memory, an EEPROM memory, a register, a hard disk, a mobile disk, a CD-ROM, or a storage medium in any other form known in the art. An schematic storage medium is coupled to the processor, thereby enabling the processor to read information from the storage medium write information in the storage medium. In an alternative solution, the storage medium may be integrated with the processor. The processor and the storage medium may reside in an ASIC that may reside in a user terminal. In another alternative solution, the processor and the storage medium may reside in the user terminal as discrete components.

In one or more schematic designs, the inactions may be implemented in hardware, software, firmware or any combination thereof. If being implemented in software, the functions may be stored in a computer-readable medium as one or more commands or codes or transmitted by means of the computer-readable medium. The computer-readable medium includes a computer storage medium, and a communication medium that may be any medium conducive to transmitting a computer program from a position to another position. The storage medium may be any available medium capable of being accessed by a general-purpose or special-purpose computer. For example only rather than limiting, the computer-readable medium may be an RAM, an ROM, an EEPROM, a CD-ROM, any other optical disk storage device or magnetic disk storage device, any other magnetic storage device, or any other medium that can be used to carry or store required program codes in the form of commands or of a data structure and can be accessed by a general-purpose or special-purpose computer or a general-purpose or special-purpose processor. Besides, any connection can be appropriately referred to as the computer-readable medium.. For example, if software is sent from a website, a server or other remote sources using a coaxial cable, an optical fiber cable, a twisted pair, a digital subscriber line (DSL), or wireless technologies such as infrared, radio and microwave, the coaxial cable, the optical fiber cable, the twisted pair, the DSL, and the wireless technologies such as infrared, radio and microwave are all covered by the definition of the medium. For example, the magnetic disk and the optical disk used herein can be compact disks (CD), laser disks, optical disks, digital video disks (DVD), soft disks, or blue-ray disks, wherein typically, the magnetic disk magnetically reproduce data, while the optical disk optically reproduce data using laser. The combinations in the above content also should fall into the scope of the computer-readable mediums.

In regard to the disclosed schematic embodiments, it should be noted that various alterations and modifications may be made to them without departing from the scope of the present disclosure defined by claims. The functions, steps and/or actions of the method claims according to the disclosed embodiments described herein do not need to be executed in any specific order. In addition, although each element of the present disclosure may be described or required in the form of an individual, multiple elements can be conceived unless a single element is explicitly limited.

It should be appreciated that unless exceptions are clearly supported by the context, the singular forms “a”, “an”, and “the” used in this text are intended to also include plural forms. It also should be appreciated that “and/or” used in this text means including any and all possible combinations of one or more than one items listed associatively.

The serial numbers of the embodiments of the present disclosure are merely meant to description, rather than indicating whether the embodiments are good or bad.

It can be understood by a person skilled in the art that implementing of all or part of steps of the above embodiments may he completed by means of hardware, or program command related hardware. The program may be stored in a computer-readable storage medium. The aforementioned storage medium may be a read-only memory, a magnetic disk. an optical disk, or the like.

Finally, it should be noted that the above embodiments are merely used for illustrating the technical solutions of the present disclosure, rather than limiting them. Although the present disclosure is illustrated in detail with reference to the aforementioned embodiments, it should be understood by a person skilled in the art that modifications may still be made to the technical solutions described in the aforementioned embodiments, or equivalent alternatives may be applied to part of technical characteristics therein; and these modifications or alternatives do not cause the nature of the corresponding technical solutions to depart from the spirit and scope of the technical solutions of the embodiments of the present disclosure.

What is claimed is:

1. A method for adjusting a panoramic video, applied to an electronic device, comprising:
obtaining a gravity sensing parameter of the electronic device;
calculating an included angle α between a direction of the gravity sensing parameter and a negative axis of an x-axis of the electronic device, the included angle α being an angle of which the direction of the gravity sensing parameter clockwise rotates to the negative axis of the x-axis, wherein a positive axis direction of the x-axis is a direction of which a center of gravity o is perpendicular to a long side of the electronic device and extends upwards; a positive axis direction of a y-axis is a direction of which the center of gravity o is perpendicular to a broad side of the electronic device and extends toward an upper part of the electronic device; a positive axis direction of a z-axis is a direction of which the center of gravity o extends in a direction that a front side of the electronic device faces; the positive axis directions of the x-axis, the y-axis and the z-axis are all determined on the basis of a direction of which the front side of the electronic device faces a user and the upper part of the electronic device is placed on a right side;
rotating a panoramic model of the panoramic video by a anticlockwise relative to the negative axis of the x-axis to keep images of the panoramic video horizontal.

2. The method according to claim 1, wherein the step of calculating the included angle α between the direction of the gravity sensing parameter and the negative axis of the x-axis of the electronic device comprises:
determining components of the gravity sensing parameter in the x-axis, the y-axis and the z-axis, respectively; wherein, the gravity sensing parameter is a gravity acceleration g,
wherein the components of the gravity acceleration g in the x-axis, the y-axis and the z-axis are gₓ, g_{y} and g_{z}, respectively;
when gₓ is less than 0 and g_{y} is greater tl an or equal to 0,
$$α = arcsin \frac{\vert {g}_{y} \vert}{\sqrt{{g}_{x}^{2} + {g}_{y}^{2}}} ;$$
when gₓ is greater than or equal to 0 and g_{y} is greater than or equal to 0,
$$α = 180 - arcsin \frac{\vert {g}_{y} \vert}{\sqrt{{g}_{x}^{2} + {g}_{y}^{2}}} ;$$
when gₓ is greater than or equal to 0 and g_{y} is less than 0,
$$α = 180 + arcsin \frac{\vert {g}_{y} \vert}{\sqrt{{g}_{x}^{2} + {g}_{y}^{2}}} ;$$
when gₓ is less than 0 and g_{y} is less than 0,
$$α = 360 - arcsin \frac{\vert {g}_{y} \vert}{\sqrt{{g}_{x}^{2} + {g}_{y}^{2}}} .$$

3. The method according to claim 1, after calculating the included angle α between the direction of the gravity sensing parameter and the negative axis of the x-axis of the electronic device, the method further comprising:
determining a state of the electronic device according to the included angle α.

4. The method according to claim 3, wherein the step of determining the state of the electronic device according to the included angle α comprises:
determining that the electronic device is In a positive landscape state when the included angle α is greater than 315 degrees and less than or equal to 360 degrees, or greater than 0 and less than or equal to 45 degrees;
determining that the electronic device is in a positive portrait state when the included angle α is greater than 45 degrees and less than or equal to 135 degrees:
determining that the electronic device is in a negative landscape state when the included angle α is greater than 135 degrees and less than or equal to 225 degrees;
determining that the electronic device is in a negative portrait state when the included angle α is greater than 225 degrees and less than or equal to 315 degrees.

5. The method according to claim 4, after determining the state of the electronic device according to the included angle α further comprising:
determining an adjustment parameter of the panoramic video according to the state of the mobile terminal.

6. The method according to claim 5, wherein the step of determining the adjustment parameter of the panoramic video according to the state of the electronic device comprises:
determining the adjustment parameter of the panoramic video as (+Δx, +Δy) when the electronic device is in the positive landscape state;
determining the adjustment parameter of the panoramic video as (−Δy, +Δx) when the electronic device is in the positive portrait state;
determining the adjustment parameter of the panoramic video as (−Δx, −Δy) when the electronic device is in the positive landscape state;
determining the adjustment parameter of the panoramic video as (+Δy, −Δx) when the electronic device is in the positive portrait state;
wherein Δx represents a displacement of the center of gravity o in the x-axis along with a change of the state of the electronic device, while Δy represents a displacement of the center of gravity o in the y-axis along with the change of the state of the electronic device.

7. An electronic device for adjusting a panoramic video, comprising:
at least one processor; and
a memory communicably connected with the at least one processor for storing instructions executable by the at least one processor, wherein execution of the instructions by the at least one processor causes the at least one processor to:
obtain a gravity sensing parameter of the electronic device;
calculate an included angle α between a direction of the gravity sensing parameter and a negative axis of an x-axis of the electronic device the included angle α being an angle of which the direction of the gravity sensing parameter clockwise rotates to the negative axis of the x-axis, wherein a positive axis direction of the x-axis is a direction of which a center of gravity o is perpendicular to a long side of the electronic device and extends upwards; a positive axis direction of a y-axis is a direction where the direction of the center of gravity o is perpendicular to a broad side of the electronic device and extends toward an upper part of the electronic device; a positive axis direction of a z-axis is a direction where the direction of the center of gravity o extends in a direction that a front side of the electronic device faces; the positive axis directions of the x-axis, the y-axis and the z-axis are all determined on the basis of a direction where the front side of the electronic device faces a user and the upper part of the electronic device is placed on a right side;
rotate a panoramic model of the panoramic video by α anticlockwise relative to the negative axis of the x-axis to keep images of the panoramic video horizontal.

8. The electronic device according to claim 7, wherein the step to calculate the included angle α between the direction of the gravity sensing parameter and the negative axis of the x-axis of the electronic device comprises:
determining components of the gravity sensing parameter in the x-axis, the y-axis and the z-axis, respectively, the gravity sensing parameter is a gravity acceleration g,
wherein the components of the gravity acceleration g in the x-axis, the y-axis and the z-axis are gₓ, g_{y} and g_{z}, respectively;
when gₓ is less than 0 and g_{y} is greater than or equal to 0,
$$α = arcsin \frac{\vert {g}_{y} \vert}{\sqrt{{g}_{x}^{2} + {g}_{y}^{2}}} ;$$
when gₓ is greater than or equal to 0 and g_{y} is also greater than or equal to 0,
$$α = 180 - arcsin \frac{\vert {g}_{y} \vert}{\sqrt{{g}_{x}^{2} + {g}_{y}^{2}}} ;$$
when gₓ is greater than or equal to 0 and g_{y} is less than 0,
$$α = 180 + arcsin \frac{\vert {g}_{y} \vert}{\sqrt{{g}_{x}^{2} + {g}_{y}^{2}}} ;$$
when gₓ is less than 0 and g_{y} is also less tlran 0,
$$α = 360 - arcsin \frac{\vert {g}_{y} \vert}{\sqrt{{g}_{x}^{2} + {g}_{y}^{2}}} .$$

9. The electronic, device according to claim 7, wherein the at least one processor is further caused to:
determine a state of the electronic device according to the included angle α after the calculating module calculates the included angle between the direction of the gravity sensing parameter and the negative axis of the x-axis of the electronic device.

10. The electronic device according to claim 9, Wherein the step to determine a state of the electronic device according to the included angle α comprises:
determining the electronic device is in a positive landscape state when the included angle α is greater than 315 degrees and less than or equal to 360 degrees, or greater than 0 and less than or equal to 45 degrees;
determining that the electronic device is in a positive portrait state when the included angle α is greater than 45 degrees and less than or equal to 135 degrees, determining that the electronic device is in a negative landscape state when the included angle α is greater than 135 degrees and less than or equal to 225 degrees; and
determining that the electronic device is in a negative portrait state when the included angle α is greater than 225 degrees and less than or equal to 315 degrees.

11. The electronic device according to claim 10, wherein the at least one processor is further caused to:
determine an adjustment parameter of the panoramic video according to the state of the electronic device.

12. The electronic device according to claim 11, wherein the step to determine the adjustment parameter of the panoramic video according to the state of the electronic device comprises:
determining the adjustment parameter of the panoramic video as (+Δx, +Δy) when the electronic, device is in the positive landscape state;
determining the adjustment parameter of the panoramic video as (−Δy, +Δx) when the electronic, device is in the positive portrait state;
determining the adjustment parameter of the panoramic video as (−Δx, −Δy) when the electronic device is in the positive landscape state, and determine the adjustment parameter of the panoramic video as (+Δy, −Δx) when the electronic device is in the positive portrait state;
wherein Δx epresents a displacement of the center of gravity o in the x-axis along with a change of the state of the electronic device, while Δy represents a displacement of the center of gravity o in the y-axis along with the change of the state of the electronic device,

13. A non-volatile computer-readable medium storing executable instructions that, when executed by an electronic device, cause the electronic device to:
obtain a gravity sensing parameter of the electronic device;
calculate an included angle α between a direction of the gravity sensing parameter and a negative axis of an x-axis of the electronic device, the included angle α being an angle of which the direction of the gravity sensing parameter clockwise rotates to the negative axis of the x-axis, wherein a positive axis direction of the x-axis is a direction of which a center of gravity o is perpendicular to a long side of the electronic device and extends upwards; a positive axis direction of a y-axis is a direction of which the center of gravity o is perpendicular to a broad side of the electronic device and extends toward a upper part of the electronic device; a positive axis direction of a z-axis is a direction of which the center of gravity o extends in a direction that a front side of the electronic device faces; the positive axis directions of the x-axis, the y-axis and the z-axis are all determined on the basis of a direction of which the front side of the electronic device faces a user and the upper part of the electronic device is placed on a right side;
rotate a panoramic model of the panoramic video by a anticlockwise relative to the negative axis of the x-axis to keep images of the panoramic video horizontal.

14. The non-volatile computer-readable medium according to claim 13, wherein the step to calculate the included angle α between the direction of the gravity sensing parameter and the negative axis of the x-axis of the electronic device comprises:
determining components of the gravity sensing parameter in the x-axis, the y-axis and the z-axis, respectively; wherein, the gravity sensing parameter is a gravity acceleration g,
wherein the components of the gravity acceleration g in the x-axis, the y-axis and the z-axis are gₓ, g_{y} and g_{y} respectively;
when gₓ is less than 0 and g_{y} is greater than or equal to 0,
$$α = arcsin \frac{\vert {g}_{y} \vert}{\sqrt{{g}_{x}^{2} + {g}_{y}^{2}}} ;$$
when gₓ is greater than or equal to 0 and g_{y} is greater than or to 0,
$$α = 180 - arcsin \frac{\vert {g}_{y} \vert}{\sqrt{{g}_{x}^{2} + {g}_{y}^{2}}} ;$$
when gₓ is greater than or equal to 0 and g_{y} is less than 0,
$$α = 180 + arcsin \frac{\vert {g}_{y} \vert}{\sqrt{{g}_{x}^{2} + {g}_{y}^{2}}} ;$$
when gₓ is less than 0 and g_{y} is less than 0,
$$α = 360 - arcsin \frac{\vert {g}_{y} \vert}{\sqrt{{g}_{x}^{2} + {g}_{y}^{2}}} .$$

15. The non-volatile computer-readable medium according to claim 13, after calculate the included angle α between the direction of the gavity sensing parameter and the negative axis of the x-axis of the electronic device, the electronic device is further caused to:
determine a state of the electronic device according to the included angle α.

16. The non-volatile computer-readable medium according to claim 15, wherein the step to determine the state of the electronic device according to the included angle α comprises:
determining that the electronic device is in a positive landscape state when the included angle α is greater than 315 degrees and less than or equal to 360 degrees, or greater than 0 and less than or equal to 45 degrees;
determining that the electronic device is in a positive portrait state when the included angle α is greater than 45 degrees and less than or equal to 135 degrees;
determining that the electronic device is in a negative landscape state when the included angle α is greater than 135 degees and less than or equal to 225 degrees;
determining that the electronic device is in a negative portrait state when the included angle α is greater than 225 degrees and less than or equal to 315 degrees.

17. The non-volatile computer-readable medium according to claim 16, after the step to determine the state of the electronic device according to the included angle α, the electronic device is further caused to:
determine an adjustment parameter of the panoramic video according to the state of the mobile terminal.

18. The non-volatile computer-readable medium according to claim 17, wherein the step to determine the adjustment parameter of the panoramic video according to the state of the electronic device comprises:
determining the adjustment parameter of the panoramic video as (+Δx, +Δy) when the electronic device is in the positive landscape state:
determining the adjustment parameter of the panoramic video as (−Δy, +Δx) when the electronic device is in the positive portrait state
determining the adjustment parameter of the panoramic video as (−Δx, −Δy) when the electronic device is in the positive landscape state;
determining the adjustment parameter of the panoramic video as (+Δy, −Δx) when the electronic device is in the positive portrait state;
wherein Δx represents a displacement of the center of gravity o in the x-axis along with a change of the state of the electronic device, while Δy represents a displacement of the center of gravity o in the y-axis along with the change of the state of the electronic device.
